(19) United States
(12) Patent Application Publication
(10) Pub. No.: US 2025/0299250 A1
(43) Pub. Date: Sep. 25, 2025

(54) AMBIENT LIGHT MANAGED DOCUMENT PROCESSING

(71) Applicant: Capital One Services, LLC, McLean, VA (US)

(72) Inventor: Timothy KINSEY, New York, NY (US)

(73) Assignee: Capital One Services, LLC, McLean, VA (US)

(21) Appl. No.: 18/613,802

(22) Filed: Mar. 22, 2024

(51) Int. Cl. G06Q 40/02; G01S 17/89; G06T 5/50; G06V 10/60; G06V 30/10

(52) U.S. Cl. CPC G06Q 40/02; G01S 17/89; G06T 5/50; G06V 10/60; G06V 30/10; G06T 2207/20221

(57) ABSTRACT

A computer implemented method, system, and non-transitory computer-readable device that may be used in a remote deposit environment. Upon receiving a user request, based on interactions with the UI, the method implements an electronic deposit of a financial instrument by activating a camera on the client device to select a virtual background to increase a contrast ratio between pixels of the financial instrument and pixels of background imagery relative to the financial instrument. The method continues by extracting data fields based on the formation of image objects of each side of the financial instrument from the live video stream of image data. The extracted data fields are communicated to a remote deposit server to complete the remote deposit.

### BACKGROUND

As financial technology evolves, banks, credit unions and other financial institutions have found ways to make online banking and digital money management more convenient for users. Mobile banking apps may let you check account balances and transfer money from your mobile device. In addition, a user may deposit paper checks from virtually anywhere using their smartphone or tablet. However, users may have to take pictures and have them processed remotely.

### BRIEF DESCRIPTION OF THE DRAWINGS

The accompanying drawings are incorporated herein and form a part of the specification.

FIG. 1 illustrates an example remote deposit check process, according to some embodiments and aspects.

FIG. 2 illustrates example remote deposit Optical Character Recognition (OCR) segmentation, according to some embodiments and aspects.

FIG. 3 illustrates a block diagram of a remote deposit system architecture, according to some embodiments and aspects.

FIG. 4 illustrates an example diagram of a client computing device determining distance and ambient light, according to some embodiments and aspects.

FIG. 5 illustrates an example set of virtual backgrounds, according to some embodiments and aspects.

FIG. 6A illustrates an ambient light managed video process, according to some embodiments and aspects.

FIG. 6B illustrates an ambient light managed video process, according to some embodiments and aspects.

FIG. 7 illustrates an example diagram of an ambient light managed remote deposit system, according to some embodiments and aspects.

FIG. 8 illustrates a flow diagram for an ambient light managed remote deposit process, according to embodiments and aspects.

FIG. 9 illustrates a block diagram of a ML system, according to some embodiments and aspects.

FIG. 10 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, computer program product embodiments, and/or combinations and sub-combinations thereof, for two-sided financial instrument processing on a mobile device or desktop computing device based on imagery, as managed by ambient light detection processes. Throughout this disclosure, ambient light may describe natural light, artificial light (e.g., from mobile device light), or a combination of both. While described in the context of financial instrument processing, the disclosed technology may be applied to any other two-sided document. The disclosed technology may be used to process images of documents during transactions, such as assisting, in real-time or near real-time, a customer to electronically deposit a financial instrument, such as a check. The imagery may be formed into image objects and be processed by an Optical Character Recognition (OCR) system. OCR includes the electronic or mechanical conversion of images of typed, handwritten, or printed text into machine-encoded text, whether from a scanned document, a photo of a document, a scene photo, a video stream of image data, etc. Using the technology described herein, data (e.g., check amount, signature, MICR line, account number, etc.) may be extracted in real-time or near-real-time from a live image stream of a check, or portions of the check (e.g., partial check images).

Mobile check deposit is a convenient way to deposit funds using a customer's mobile device or laptop. As technology and digital money management tools continue to evolve, the process has become safer and easier. Mobile check deposit is a way to deposit a financial instrument, e.g., a paper check, through a banking app using a smartphone, tablet, laptop, etc. In current systems, mobile deposit may request a user to process a plurality of pictures of a check using, for example, their smartphone or tablet camera and upload them through a mobile banking app running on the mobile device. Deposits commonly include personal, business, or government checks.

In current remote deposit systems and processes, computer-based (e.g., laptop) or mobile-based (e.g., mobile device) technology allows a user to initiate a document uploading process for uploading an image(s) or other electronic versions of a document to a backend system (e.g., a document processing system) for various purposes, including evaluating the quality of the captured image(s). This current process has disadvantages, such as, requiring the customer to capture and communicate check imagery and, if determined to be of poor quality, following-up with additional images. For example, a poor contrasting background surface visibly encapsulating at least a portion of the check may prevent or hinder a determination or capture of the check boundaries or content within these boundaries. In another example, too much ambient light (e.g., to include reflections), or too little ambient light (e.g., dark) may reduce the quality of imagery. These poor contrasting backgrounds may be inefficient and consume client, system, and network resources that otherwise could be allocated to other tasks. Alternatively, a frustrated user may take their deposit to another financial institution, causing a potential duplicate presentment or fraud issue.

In one aspect, an ambient light sensor, resident on a client device, manages image object processing sequences. For example, the customer initiates a remote deposit process by opening an application (app) and then making a request to deposit a check. The process, once initiated, activates a camera on the client device to begin streaming raw imagery. An ambient light sensor may determine that a check and its background do not have a contrast ratio above a threshold to allow for a proper recognition of the check boundaries. In cases where the contrast ratio is not above a preset threshold, a virtual background (e.g., graphical overlay) may be selected by a machine learning (ML) algorithm (e.g., by a virtual background selection ML model). The model may select a virtual background from a set of backgrounds to maximize the contrast ratio. The selected virtual background is overlaid as a new background surrounding the check by replacing the original pixels, thus eliminating errors caused by low contrast backgrounds. While described as an overlay, in some aspects, the virtual background is not rendered, but rather is used as substitute pixel values (e.g., color and luminance) for pixels located within the original image background area. In some aspects, the selected virtual background is rendered on a client device as a graphical overlay on additional images during a remote deposit check process. In some aspects, the selected virtual background is separately determined for each additional image during a common remote deposit check process. These processes may be directed by a mobile banking app or other image processing app and the video processed by an OCR process in real-time or near real-time.

In one aspect, a Light Detection and Ranging (LIDAR) based sensor resident on a client device manages image object processing sequences. For example, the customer initiates a remote deposit process by opening an application (App) and then making a request to deposit a check. The process, once initiated, activates a camera on the client device to begin streaming raw imagery. A LIDAR sensor may determine that a check is within a known distance or distance range (e.g., in focus) and is not moving. The known distance may be input to the virtual background selection ML model to improve a selection of the virtual background from a set of backgrounds to maximize the contrast ratio. These processes may be directed by a mobile banking app or other image processing app and the video processed by an OCR process in real-time or near real-time.

This technical solution improves a likelihood of processing quality imagery in poor lighting conditions and thus is more efficient, requires less client, system, and network resources, improves user experience, and may reduce instances of accidental duplicate check presentation. In some embodiments, the technology described herein continuously evaluates a contrast ratio of image data/background image data from an activated camera of a mobile device or other customer device. One or more high quality image frames (e.g., entire image of check image), or portions thereof, may subsequently be OCR processed to extract data fields locally or, alternatively, in a remote OCR process.

In some embodiments and aspects disclosed herein, the OCR process may be implemented with an active OCR process using a mobile device, instead of after submission of imagery to a backend remote deposit system. However, other known and future OCR applications may be substituted without departing from the scope of the technology disclosed herein.

Active OCR is further described in U.S. application Ser. No. 18/503,778, entitled “Active OCR,” filed Nov. 7, 2023, and incorporated by reference in its entirety. Active OCR, includes performing OCR processing on image objects formed from a raw live video stream of image data originating from an activated camera on a client device. The image objects may include portions of a check or an entire image of the check. As a portion of a check image is formed into a byte array, it may be provided to the active OCR system to extract any data fields found within the byte array in real-time or near real-time. In a non-limiting example, if the live video streamed image data contains an upper right corner of a check formed in a byte array, the byte array may be processed by the active OCR system to extract the origination date of the check.

In some embodiments, the camera continuously streams video for each side of the check data until all of the data fields have been extracted from the imagery. In some embodiments, various check framing elements, such as a border or corners, may assist in alignment of continuously video streaming data fields, corresponding Byte Array Output Video stream objects, and flip detection. In some embodiments, success of the OCR extraction process may be determined based on reaching an extraction quality threshold. For example, if a trained machine learning (ML) OCR model reaches a determination of 85% surety of a correct data field extraction, then the OCR process for that field may be considered complete. Utilizing this capability, the OCR data may be communicated to a banking backend for additional remote deposit processing. Implementing the technology disclosed herein, the deposit may be processed by a mobile banking app and a remote deposit status rendered on a user interface (UI) mid-experience (for example, at or around the time that the user processes an image of the check for remote deposit). Alternatively, or in addition to, portions of the remote deposit sequence may be processed locally on the client device.

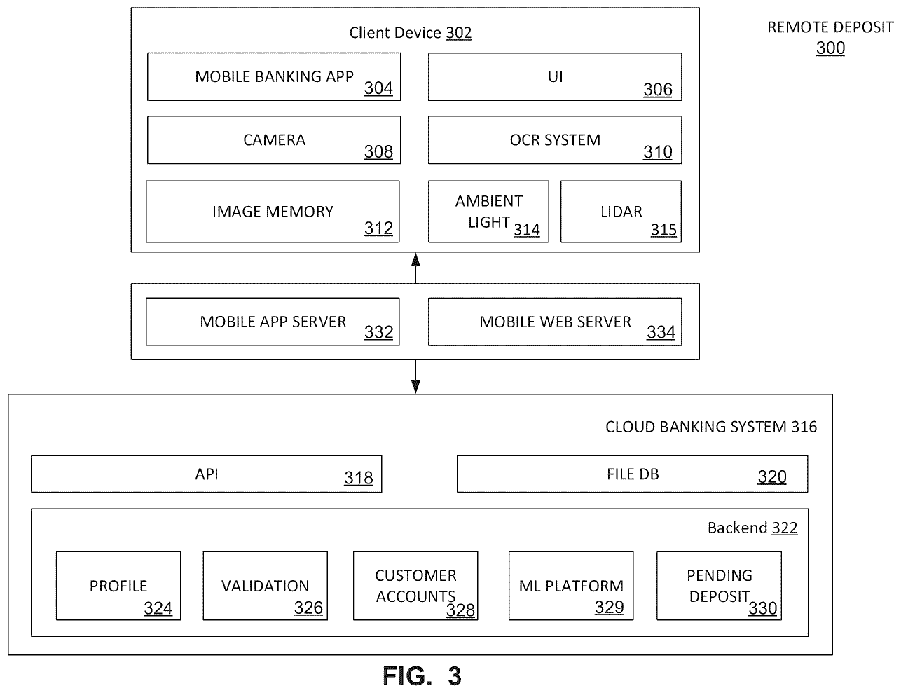

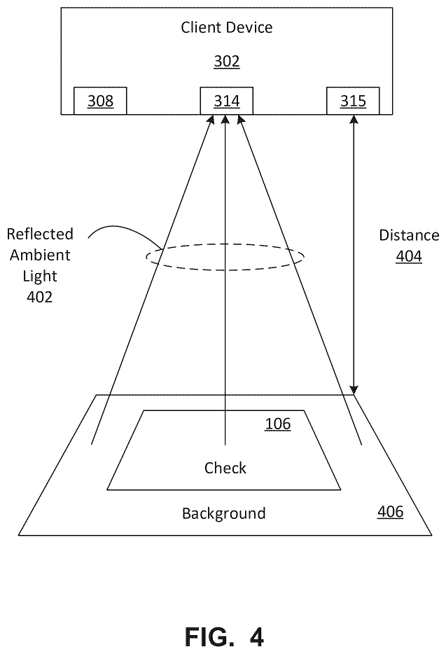

Various aspects of this disclosure may be implemented using and/or may be part of the remote deposit systems shown in FIGS. 3-4. It is noted, however, that this environment is provided solely for illustrative purposes, and is not limiting. Aspects of this disclosure may be implemented using and/or may be part of environments different from and/or in addition to the remote deposit system, as will be appreciated by persons skilled in the relevant art(s) based on the teachings contained herein. An example of the remote deposit system shall now be described.

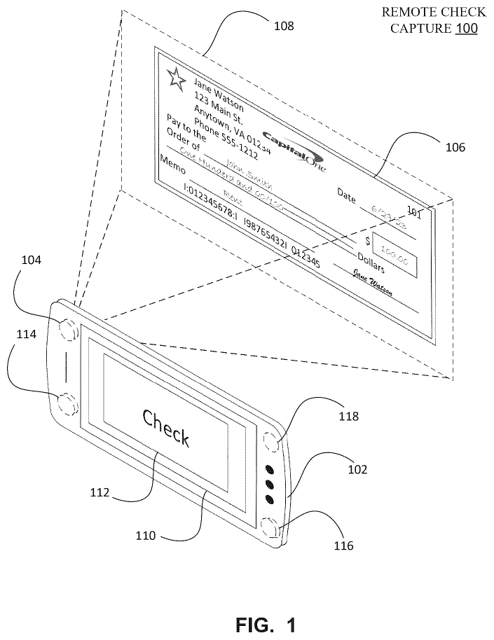

FIG. 1 illustrates an example remote check process 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106, may be a personal check, paycheck, or government check, to name a few. In some embodiments, a customer will initiate a remote deposit check process from their mobile computing device (e.g., smartphone) 102, but other digital video camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer will select a bank account (e.g., checking or savings) into which the funds specified by the check are to be deposited. Content associated with the document include the funds or monetary amount to be deposited to the customer's account, the issuing bank, the routing number, and the account number. Content associated with the customer's account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104 (e.g., open a camera port). One skilled in the art would understand that variations of this approach or functionally equivalent alternative approaches may be substituted to initiate a mobile deposit.

In a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, active OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

Using the camera 104 function on the mobile computing device 102, the customer frames imagery (e.g., image frames or live video) from a field of view 108 that includes at least a portion of one side of a check 112. Typically, the camera's field of view 108 will include at least the perimeter and background of the check. However, any camera position that generates in-focus imagery of the various data fields located on a check may be considered. Resolution, distance, alignment, and lighting parameters may require movement of the mobile device until a proper view of a complete check, in-focus, has occurred. In some aspects, camera 104, LIDAR sensor 114, ambient light sensor 116, and/or gyroscope sensor 118, may process image, light, distance, and/or angular position to assist in detecting ambient light of the environment or a distance of the check, as will be described in greater detail herein.

An application running on the mobile computer device 102 may automatically generate proper framing of a check within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the check viewing occurs. For example, low light, bright light, or reflections may require specific virtual background selections. Alternatively, the camera can be remote to the mobile computing device 102. In an alternative embodiment, the remote deposit is implemented on a desktop computing device with an accompanying digital camera.

Sample customer instructions may include, but are not limited to, “Once you've completed filling out the check information and signed the back, it's time to view your check,” “Select the camera icon in your mobile app to open the camera,” “Once you've taken video of the front of the check, flip the check to take video of the back of the check,” “Do you accept the funds availability schedule?,” “Swipe the Slide to Deposit button to submit the deposit,” “Your deposit request may have gone through, but it's still a good idea to hold on to your check for a few days,” “keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

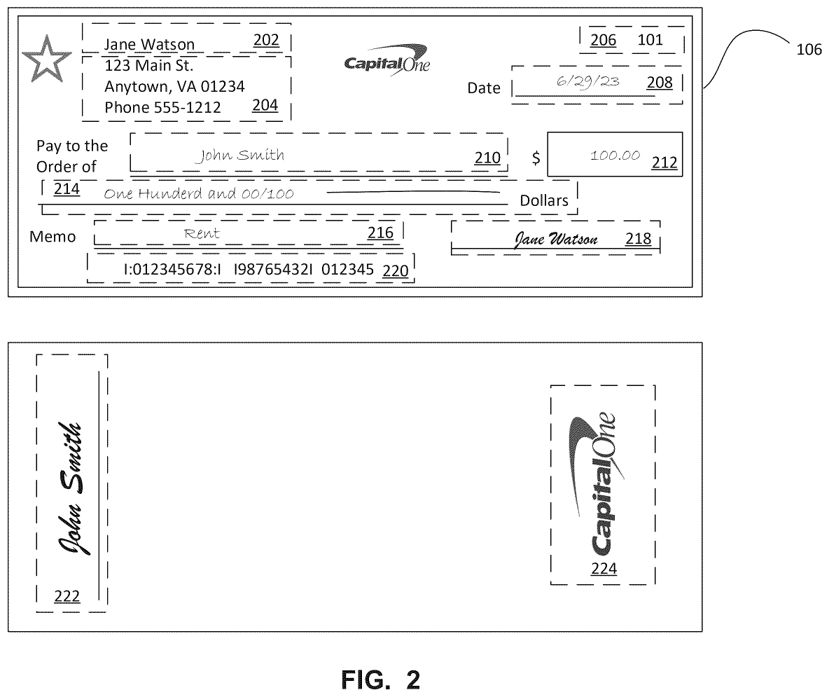

FIG. 2 illustrates example remote deposit OCR segmentation, according to some embodiments and aspects. Depending on check type, a check may have a fixed number of identifiable fields. For example, a standard personal check may have front side fields, such as, but not limited to, a payor customer name 202 and address 204, check number 206, date 208, payee field 210, payment amount 212, a written amount 214, memo line 216, Magnetic Ink Character Recognition (MICR) line 220 that includes a string of characters including the bank routing number, the payor customer's account number, and the check number, and finally, the payor customer's signature 218. Back side identifiable fields may include, but are not limited to, payee signature 222 and security fields 224, such as a watermark.

While a number of fields have been described, it is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in a mobile banking app running on the mobile computing device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In one embodiment, OCR processing of the check imagery may include implementing instructions resident on the customer's mobile device to process each of the field locations on the check as they are detected or systematically (e.g., as an ordered list extracted from a byte array output video stream object). For example, in some aspects, the check imagery may reflect a pixel scan from left-to-right or from top-to-bottom with data fields identified within a frame of the check as they are streamed.

In one non-limiting example, the customer holds their smartphone over a check (or checks) to be deposited remotely while the imagery may be formed into image objects, such as, byte array objects (e.g., frames or partial frames), ranked by confidence score (e.g., quality), and top confidence score byte array objects sequentially OCR processed until data from each of required data fields has been extracted as described in non-provisional patent application Ser. No. 18/503,787 filed Nov. 7, 2023, entitled Burst Image Capture, and incorporated by reference in its entirety herein. Alternatively, the imagery may be a blend of pixel data from descending quality image objects to form a higher quality (e.g., high confidence) blended image that may be subsequently OCR processed, as per non-provisional patent application Ser. No. 18/503,799 filed Nov. 7, 2023, entitled Intelligent Document Field Extraction from Multiple Image Objects, and incorporated by reference in its entirety herein.

In another non-limiting example, fields that include typed information, such as the MICR line 220, check number 206, payor customer name 202 and address 204, etc., may be OCR processed first from the byte array output video stream objects, followed by a more complex or time intensive OCR process of identifying written fields, which may include handwritten fields, such as the payee field 210, written amount 214, payor signature 218, to name a few.

In another example embodiment, artificial intelligence (AI), such as machine-learning (ML) systems, may train a model to select a virtual background image, determine a quality of a frame or partial frame of image data, or an OCR model(s) to recognize characters, numerals or other check data within the data fields of the video streamed imagery. The various ML models may be resident on the mobile device and may be integrated with or be separate from a banking application (app). The ML models may be continuously updated by future images or transactions used to train the ML model(s).

ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data,” in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific process to capture relationships between concepts (e.g., image clarity vs. recognition of specific characters or numerals) and a success history. The classifier (discriminator) is trained to distinguish (recognize) variations. Different variations may be classified to ensure no collapse of the classifier and so that variations can be distinguished.

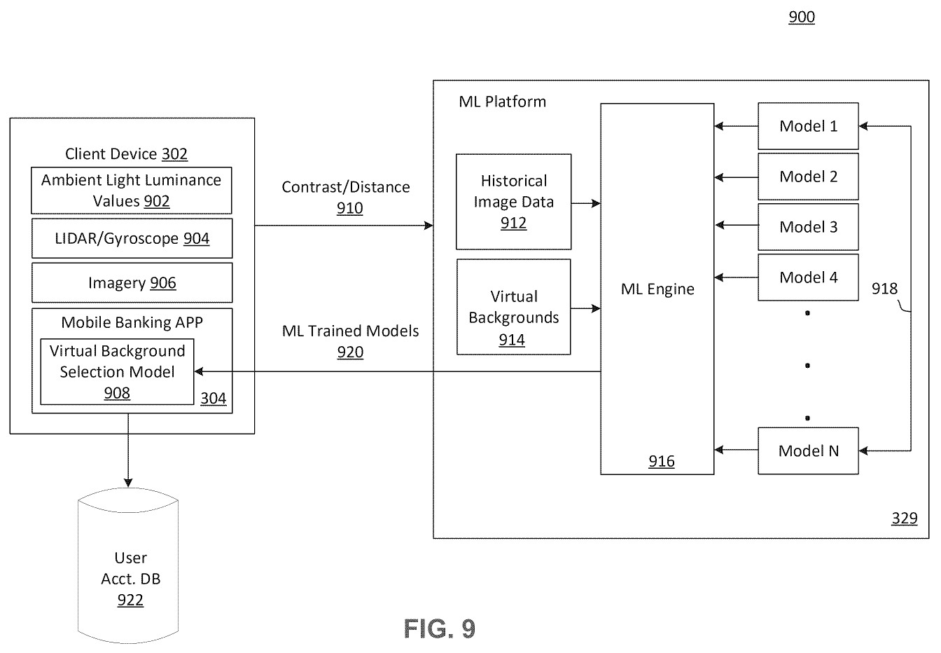

In some aspects, machine learning models are trained on a remote machine learning platform (e.g., see FIG. 3, element 329 and FIG. 9) using other customer's transactional information (e.g., previous remote deposit transactions). For example, large training sets of remote deposits with check imagery may be used to normalize prediction data (e.g., not skewed by a single or few occurrences of a data artifact). Thereafter, a predictive model(s) may classify a specific image against the trained predictive model to predict a virtual background that may replace an existing background, based on ambient light and a contrast ratio of reflected ambient light from the check, as compared to reflected ambient light from a background, and generate a confidence or threshold score. In one embodiment, the predictive models are continuously updated as new remote deposit financial transactions or check imagery become available.

In some aspects, a ML engine may continuously change weighting of model inputs to increase customer interactions with the remote deposit procedures. For example, weighting of specific data fields may be continuously modified in the model to trend towards greater success, where success is recognized by correct data field extractions or by completed remote deposit transactions. Conversely, input data field weighting that lowers successful interactions may be lowered or eliminated.

FIG. 3 illustrates a remote deposit system architecture 300, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as checks. The client device 302 is configured to communicate with a cloud banking system 316 to complete various phases of a remote deposit as will be discussed in greater detail hereafter.

In various aspects, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 is a computer program or software application designed to run on a mobile device such as a phone, tablet, or watch. However, in a desktop application implementation, a mobile banking app equivalent may be configured to run on desktop computers, and web applications, which run in web browsers rather than directly on a mobile device. Apps are broadly classified into three types: native apps, hybrid and web apps. Native applications are designed specifically for a mobile operating system, such as, iOS or Android. Web apps are designed to be accessed through a browser. Hybrid apps may function like web apps disguised in a native container.

Financial instrument imagery may originate from, but is not limited to, video streams (e.g., series of pixels or frames). A customer using a client device 302, operating a mobile banking app 304 through an interactive UI 306, frames at least a portion of a check (e.g., identifiable fields on front or back of check) within a field of view of a camera 308.

In one aspect, the camera imagery is video streamed as encoded text, such as a byte array. Alternatively, or in addition to, the video is buffered by storing (e.g., at least temporarily) as images or frames in computer memory. For example, live video streamed check imagery from camera 308 is stored locally in image memory 312, such as, but not limited to, a frame buffer, a video buffer, a video streaming buffer, or a virtual buffer.

In a first non-limiting example, pixels are detected in streamed imagery, image frames, or image byte array objects, which include check image components. For example, ambient light sensor 314 measures luminance values of reflected ambient light from surfaces of a check and surrounding surfaces (e.g., background). In some aspects, LIDAR sensor 315 (e.g., LIDAR sensor 114) may determine a distance of these surfaces during image processing. A first set of contiguous pixels of a known color and luminance level may signify pixels of a check. In addition, a second set of contiguous pixels of a known color and luminance level may signify pixels from an area of a non-check component (e.g., background). A contrast ratio confidence score may subsequently be calculated based on a contrast ratio of a first set of lighter image pixels of a first color versus a second set of darker image pixels of a second color.

In some aspects, only a portion of pixels within the first and second sets may need to be specifically considered to establish the two contiguous pixel sets. For example, in some scenarios, ancillary pixels, such as those represented by one or more light sources, reflections, or objects of other colors and luminosities may be present in a background area. In another example, pixels containing printed, typed or written elements (e.g., inks) on the check may be of a different color and luminosity than a base color of the check. In some aspects, these ancillary objects or pixels with check ink are not needed to determine a perimeter of the check and therefore their effect may be diminished or excluded. In one aspect, the first and second sets of image pixels may each be treated as a single value by averaging luminance values within similar luminosity ranges as representing a common set. Alternatively, or in addition to, a set of luminance values may be generated by considering a mean luminance value, by taking a highest or lowest luminance value, or by a highest pixel count per contiguous area (e.g., dominant color and luminosity), etc. Alternatively, or in addition to, in some aspects, the system may ignore the affecting pixels (e.g., pixels with known MICR ink color) when establishing the contiguous sets or determining their contrast ratio(s).

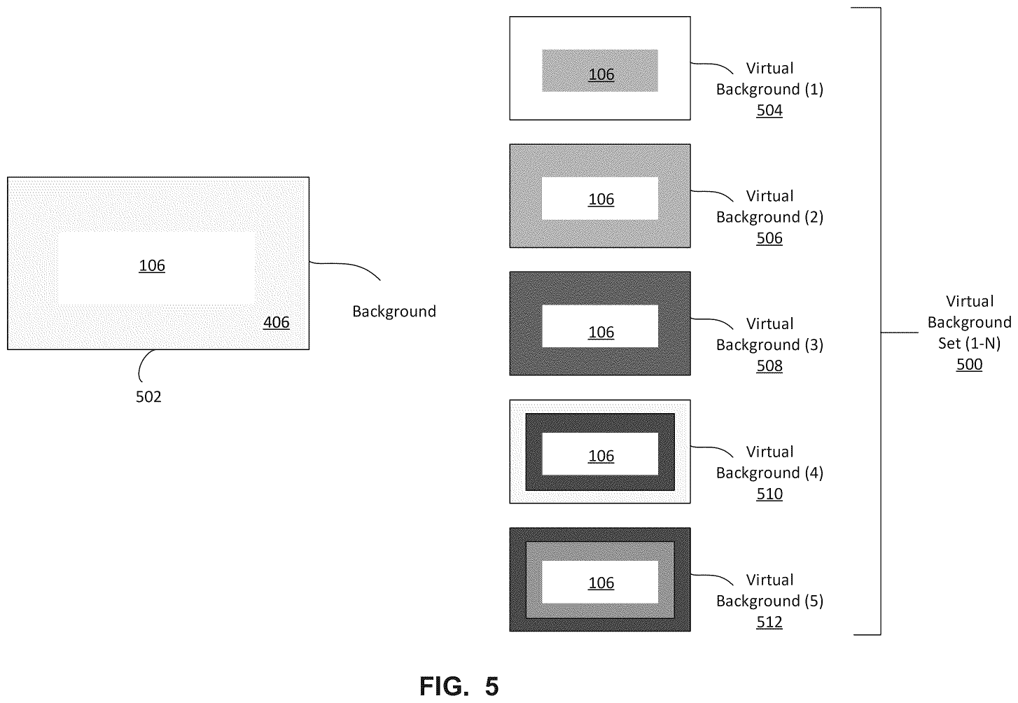

In some aspects, to assist in establishing two or more sets of contiguous pixel areas, respectively representing the check and its background, a processor or graphics processor (not shown) of the client device 302 graphics may process pixels as a set when they are co-located within graphical area of an image. In a non-limiting example, the graphical area of an image may include one or more nested quadrilateral areas (e.g., as shown in FIG. 5, element 502). For example, pixels of one pixel color and/or luminosity (e.g., check) may reside inside an interior quadrilateral (e.g., rectangle) area and another contiguous pixel set may reside in a surrounding exterior quadrilateral (e.g., rectangular area around the check), or at least in a portion of it. Alternatively, or in addition to, in some aspects, adjacent linear rows of pixels of lighter and the darker luminosity groups may be assist in establishing a graphical area or contiguous pixel set. For example, a first linear pixel sequence of a first color may abut a second linear pixel sequence of a second color and may be used to establish one side of a graphical area.

In some aspects, when the camera is positioned orthogonal and centered with the check, the graphical area may be represented as a rectangle. However, when the camera is at an angle relative to the check, the shape of the graphical area may be skewed, such as, but not limited to, a trapezoidal shape (e.g., see FIG. 4, elements 106/406), or an irregular quadrilateral (e.g., when the camera is offset in position relative to a corner). In another aspect, vertices of the check or background (e.g., corners), may be used to establish a graphical area. For example, a quadrilateral shape may be determined by identifying at least 3 corners of the check. In a non-limiting example, an identified left-top and left-bottom corner would establish the height of the interior quadrilateral shape (e.g., check area), while further identifying a right corner (top or bottom) would establish a length of the interior quadrilateral shape. Alternatively, a left-top and right-top corner would establish the length of the interior quadrilateral shape, while a lower corner (right or left) would establish a length of the quadrilateral shape. Similar geometric considerations may be used to establish the exterior graphical shape (e.g., background frame).

In some aspects, the contrast ratio score may be predicted by a ML model trained on previous images, with assigned luminosity values and contrast ratio scores, or specific contrast ratio thresholds. Alternatively, or in addition to, in one aspect, the ML model may generate a total pixel contrast score for the lighter pixels versus darker pixels. For example, using machine learning, thousands or millions of images may be processed to accurately recognize and categorize these pixels.

In some embodiments, OCR system 310, resident on the client device 302, processes the imagery based on live video streamed check imagery from camera 308 to extract data by identifying specific data located within known sections (non-background) of the check to be electronically deposited. In one non-limiting example, single identifiable fields, such as the payor customer name 202, MICR data field 220 identifying customer and bank information (e.g., bank name, bank routing number, customer account number, and check number), date field 208, check amount 212 and written amount 214, and authentication (e.g., payee signature 222) and security fields 224 (e.g., watermark), etc., shown in FIG. 2, are processed by the OCR system 310.

OCR system 310 communicates data extracted from the one or more data fields during the active OCR operation to cloud banking system 316, shown in FIG. 3. For example, the extracted data identified within these fields is communicated to file database (DB) 320 either through a mobile app server 332 or mobile web server 334 depending on the configuration of the client device (e.g., mobile or desktop). In one aspect, the extracted data identified within these fields is communicated through the mobile banking app 304.

Alternatively, or in addition to, a thin client (not shown) resident on the client device 302 processes extracted fields locally with assistance from cloud banking system 316. For example, a processor (e.g., CPU) implements at least a portion of remote deposit functionality using resources stored on a remote server instead of a localized memory. The thin client connects remotely to the server-based computing environment (e.g., cloud banking system 316) where applications, sensitive data, and memory may be stored.

In one embodiment, imagery is processed from camera 308, as communicated from an activated camera over a period of time, until an OCR operation (e.g., active OCR) has been completed. For example, a plurality of images (e.g., frames), or partial images (e.g., blocks), are processed by OCR system 310 to identify as many data fields as possible. Subsequently, the additional images may be processed by OCR system 310 to extract any data fields missing from the first image OCR and so on until all data fields from the check have been captured. Alternatively, or in addition to, specific required data fields (e.g., amount, MICR, etc.) may be identified first in a first OCR of a first image or partial image, followed by subsequent data fields (e.g., signature) in subsequent mages.

In one embodiment, a flip detector (not shown) detects a check position sequence of front facing, flip, and back facing. Various mechanisms may detect this sequence based on any of, or a combination of, a shape of an overlaid virtual background, position, vision, sound, or multiple document analytics. One example of flip detection is further described in U.S. application Ser. No. 18/584,453, entitled “Managed Video Capture,” filed Feb. 22, 2024, and incorporated by reference in its entirety.

Backend 322, may include one or more system servers processing banking deposit operations in a secure environment. These one or more system servers operate to support client device 302. API 318 is an intermediary software interface between mobile banking app 304, installed on client device 302, and one or more server systems, such as, but not limited to the backend 322, as well as third party servers (not shown). The API 318 is available to be called by mobile clients through a server, such as a mobile edge server (not shown), within cloud banking system 316. File DB stores files received from the client device 302 or generated as a result of processing a remote deposit.

Profile module 324 retrieves customer profiles associated with the customer from a registry after extracting customer data from front or back images of the financial instrument. Customer profiles may be used to determine deposit limits, historical activity, security data, or other customer related data.

Validation module 326 generates a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316 or third party systems or data.

Customer Accounts 328 (consistent with customer's accounts 408) includes, but is not limited to, a customer's banking information, such as individual, joint, or commercial account information, balances, loans, credit cards, account historical data, etc.

ML Platform 329 may generate a trained virtual background selection model, quality confidence model, and/or OCR model (e.g., active OCR) using a ML engine. This disclosure is not intended to limit the ML Platform 329 to only virtual background selection model generation, as it may also include, but not be limited to, remote deposit models, risk models, funding models, security models, etc.

When remote deposit status information is generated, it is passed back to the client device 302 through API 318 where it is formatted for communication and display on the client device 302 and may, for example, communicate a funds availability schedule for display or rendering on the customer's device through the mobile banking app UI 306. The UI may instantiate the funds availability schedule as images, graphics, audio, additional content, etc.

Pending deposit 330 includes a profile of a potential upcoming deposit(s) based on an acceptance by the customer through UI 306 of a deposit according to given terms. If the deposit is successful, the flow creates a record for the transaction and this function retrieves a product type associated with the account, retrieves the interactions, and creates a pending check deposit activity.

Alternatively, or in addition to, one or more components of the remote deposit process may be implemented within the client device 302, third party platforms, the cloud-based banking system 316, or distributed across multiple computer-based systems. The UI may instantiate the remote deposit status as images, graphics, audio, additional content, etc. In one technical improvement over current processing systems, the remote deposit status is provided mid-video stream, prior to completion of the deposit. In this approach, the customer may terminate the process prior to completion if they are dissatisfied with the remote deposit status.

In one aspect embodiment, remote deposit system 300 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to the ML platform 329 to enhance future training of any of the ML models disclosed herein. For example, in some embodiments, one or more inputs to the ML models may be weighted differently (higher or lower) to effect a predicted higher successful outcome.

FIG. 4 illustrates an example diagram of a client device 302, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

Client device 302, in various embodiments, may be used to process imagery of a document, such as a check 106 during a remote deposit process. A camera 308, proximate (e.g., 1-3 feet) to a document, is used to process imagery within a camera's field of view 108 (see FIG. 1). In some embodiments, ambient light sensor 314 may measure ambient light reflected 402 from proximate surfaces within the camera's field of view 108. Ambient light sensor 314 may be found within devices with cameras and/or displays, such as, but not limited to, smartphones, notebooks, personal computers, HMDs, or other client devices. In some aspects, the ambient light sensor 314 may be a photodetector that is used to sense an amount of ambient light present. The standard international unit for the illuminance for ambient light is the lux. A non-limiting example performance of an ambient light sensor may be from less than 50 lux in dim light to over 10,000 lux, but the ambient light sensor 314 is not limited to these values. Ambient light sensor 314 may include phototransistors, photodiodes, and/or photonic integrated circuits, which integrate a photodetector and an amplifier in one device.

When the camera is activated (e.g., camera function selected), ambient light sensor 314 senses light levels as they are reflected from a surface, such as, that of a check 106 or a visible background surface 406 that the check is positioned on. For example, a desk that a check is positioned on would visibly surround the check area imagery. Ambient light would be reflected from both surfaces. As previously described, ambient light may describe natural light, artificial light (e.g., from a light on the client device 302), or a combination of both. In all scenarios, the ambient light sensor 314 senses light incident on the sensor, regardless of its source. As previously described, ambient light sensor 314 will measure luminance values of pixels of various colors within the field of view 108.

In some embodiments, a LIDAR sensor 315 measures distance 404 from the camera to the document (e.g., check 106), the background distance or both distances. As will be described in greater detail hereafter, distance may be used as an additional input when evaluating contrast ratios between the check reflected ambient light and the surface reflected ambient light in a machine learning environment. The inverse square law shows that when light travels twice the distance its area grows four times as large and the brightness decreases by four times. Therefore, ambient light entering the sensor will be reduced as the distance is increased. In a non-limiting machine learning implementation example, distance may be a weighted ML parameter for a series of images used to train a ML model by categorizing the training images as at or within a range of known distances. Knowing the current distance, the trained ML model may compare measured ambient light values to models trained by imagery categorized at a similar distance or range of distances.

FIG. 5 illustrates an example diagram of virtual background selections, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

When attempting to process imagery of a check, determining the boundary of the check assists the imaging process, as only pixels associated with the surface area of the check are needed for a subsequent OCR process to identify data fields on the check. In various embodiments, ambient light sensor 314, resident on a client device 302, manages image object processing sequences. For example, the user initiates a remote deposit process by opening an application (App) and then making a request to deposit a check. The process, once initiated, activates a camera 308 on the client device to begin generating a raw imagery stream. Ambient light sensor 314 may determine, using any of the methods described herein, that a check 106 and its current background 406 do not have a contrast ratio above a threshold needed to determine the boundaries of check. For example, in cases where the check luminance values are bright and the background also has bright luminance values, it may be difficult or impossible to define a perimeter of the check. In another example, if the imagery of the check is in a low light setting, the check and background luminance values may both be dark with very low contrast ratios.

In cases where the contrast ratio of light-to-dark pixels is not above a preset threshold, a virtual background will be selected from virtual background set (1-N) 500 of virtual background overlays that meets or exceeds the threshold (e.g., 5-10 virtual backgrounds). In a non-limiting example, a 1000:1 contrast ratio means that the brightest white is 1000× brighter than the darkest black and will allow a clear demarcation of the check image/background boundary. However, a 100:1 contrast ratio may not allow the system to determine a perimeter of the check 106 against a similar background. In one aspect, a machine learning (ML) algorithm (e.g., a virtual background selection ML model) will select a virtual background that meets or exceeds a selected contrast ratio threshold (e.g., above 500:1). The technology disclosed herein does not require a specific contrast ratio or threshold, but may be implemented with various contrast ratios and thresholds without departing from the scope of the technology disclosed herein.

As shown in FIG. 5, image 502 includes a check 106 and background 406 with contiguous pixel regions of similar bright luminance values and therefore these regions may appear to the ambient light sensor 314 as same regions of a low contrast ratio and therefore fail to provide a well-defined demarcation line in-between. In this case, a darker virtual background exceeding a preset contrast ratio, such as example virtual backgrounds 2-3 (506 or 508), may be automatically selected and overlaid as a new background surrounding the lightest luminance values, thus eliminating errors caused by low contrast backgrounds. In an example, where the check area pixels and background are darker (e.g., low light environment), a light virtual background, such as, virtual background 1 (504) may be selected. In other words, a virtual background of any color and pixel luminance value may be selected from the set of virtual backgrounds, as long as it meets or exceeds the selectable contrast ratio. In addition, while shown for an image that includes an entire check 106, the techniques described herein may be extended to portions of image blocks that may contain only a portion of a check image by overlaying a corresponding partial virtual background.

In these examples, instead of directing the user to place the check on a darker or lighter surface, the system will automatically select a high contrast virtual background as a substitute for at least a portion of pixels surrounding the check. In some aspects, imagery frames processed before the selection of the virtual background may be discarded and new imagery subsequently processed with a persistent virtual overlay selection. For example, once the virtual background is determined, it is placed around the check imagery area to replace at least a portion of the pixels outside the perimeter of the check for subsequent image processing steps (e.g., OCR processes). Alternatively, a distinct virtual background may be determined for each image frame, partial image frame, or group of image frames. In some aspects, the virtual background may be displayed to the user on a UI of the client device 302. In some aspects, during image processing, pixels within the field of view 108 that fall outside an area covered by the virtual background are removed, discarded, or ignored for purposes of check image area pixel processing. In some aspects, once the perimeter of the check has been identified by the virtual background, pixels that also fall within the area covered by the virtual background are removed, discarded, or ignored for purposes of check image area pixel processing. The elimination of pixels located within the field of view 108 of the camera, but outside the check may reduce overall image processing time and resource requirements allocated to the image processing of the check 106.

In one aspect, a virtual background may be reduced in size to a thinner frame area in an area immediately proximate to the check area pixels, such as shown in virtual background 4 (510). The thin frame may satisfy the contrast ratio thresholds or be a multi-contrast nested frame area, such as shown by virtual background 5 (512), where two differing contrasting fame colors may be overlaid in a nested arrangement creating a bullseye effect. As described above, only pixels inside of this virtual background frame would need to be processed within the field of view 108.

In some aspects, as the camera may move slightly during imaging, the virtual background may be continuously adapted to remap, for example, to the perimeter pixels of the check. For example, when the camera is positioned at an angle relative to the check, the shape of the check may be skewed, such as, but not limited to, a trapezoid (see FIG. 4, elements 106/406, when at an angle of incidence centered with the check) or an irregular quadrilateral (e.g., when the camera is at an angle relative to a corner of the check). In these scenarios, the shape of the virtual background may be updated to correspond to the new check shape as it changes. In another aspect, one or more vertices of the check (e.g., corners), may be used to establish and update a position of the virtual background around the perimeter of the check. For example, as the check corners move, positions of the interior corners of the virtual background may be correspondingly registered to these points.

In one aspect, imagery of a first side is processed, followed by a flip pause and then processing of second side imagery. The virtual background shape may be analyzed to determine a flip occurrence. For example, the shape of the check changes as it is flipped over from front-to-back or vice-versa. In this scenario, the shape of the virtual background would change to correspond to the changing check shape. A changing shape may subsequently be an input to the image processing to pause the overlay of the virtual background and OCR processing until the original virtual background shape was identified again (e.g., check flip has been completed). In one non-limiting example, the virtual background may appear rectangular, or trapezoidal in shape when viewed at an angle, but would have a rapid and continuously changing shape during a flip sequence. In one aspect, the shape, a range of expected shape changes (e.g., for small movements of the client device 302 during video processing), a shape change rate (e.g., very rapid during a flip), or a combination may be used to detect the flip sequence. While described for a few shapes, this disclosure is not to be limited thereto, as other shapes and image processing approaches for shape detection and modification may be substituted for the examples provided herein.

While described for a single check image, camera 308 may output one or more video frames, or partial frames, having one or more real-world objects that are within the field of view 108. For instance, a video frame may represent an entire group of checks within a field of view of camera 308, or may represent one or more individual objects within the group of checks. For example, an image processing system, resident on client device 302, may determine that more than one check is present in a field of view 108 of the camera (e.g., while the client device 302 is still or as it scans a group of multiple checks). In a first aspect, each of the checks are processed separately as previous described. In a second aspect, the checks are processed in parallel, adding a selected virtual background around each check for each of the front facing positions, all checks are then flipped, and then the back facing position is processed for the multiple checks present. In a hybrid model, each of the checks may be processed individually with a plurality processed in parallel. For example, a user may group the checks in rows and process the complete rows in parallel, with any extra checks not in rows (e.g., an odd number) processed individually.

In one non-limiting aspect, a ML model is trained on hundreds or thousands of multiple check remote deposit transactions with different numbers of checks, sizes, or types to generate a multiple check model that may predict that multiple checks are being processed by the video. In one aspect, the multiple document analysis module provides individual check positions to the mobile banking app to coordinate processing of front and back facing video for each individual check in the multiple check scenario. Alternatively, or in addition to, the multiple document analysis provides multiple check positions to the mobile banking app to coordinate processing of front and back facing video for a group of checks in the multiple check environment.

Based on an OCR process, extracted data may be continuously transmitted, periodically transmitted, or be transmitted after completion of the active OCR process (e.g., after all data fields are extracted), as check data fields to a cloud banking system 316 via a network connection.

The technical solution disclosed above allows for an accurate determination of the check imagery perimeters to properly process check imagery. This solution also improves the quality of the check processing, accelerates the remote check deposit process, and allows for automatic imagery generation without requiring user actions (e.g., moving the check to a higher contrast surface), as well as the other technical advantages described throughout this disclosure.

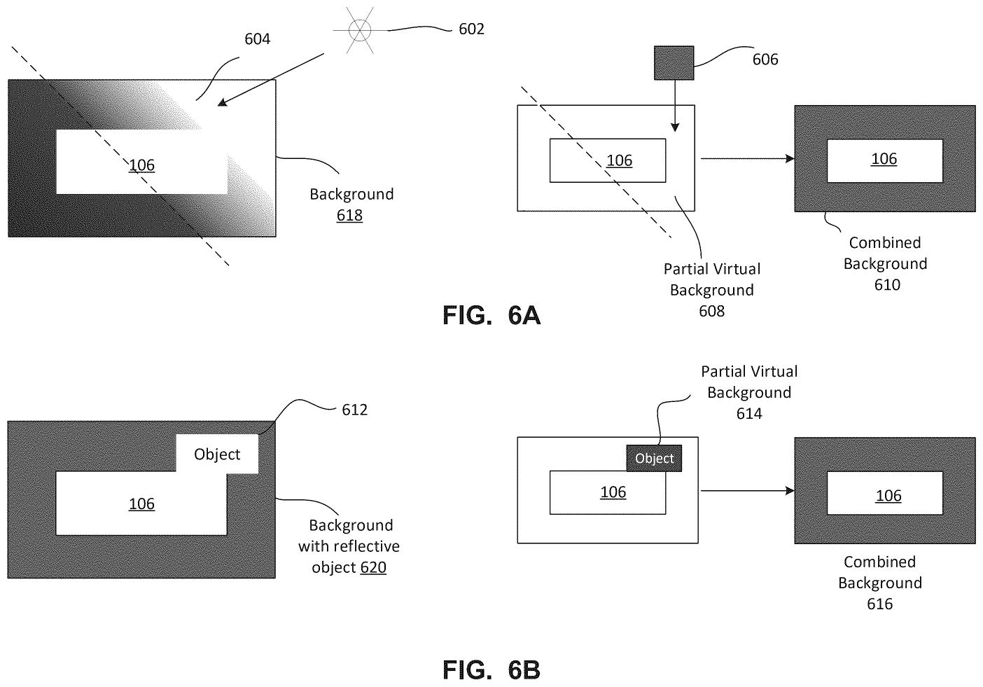

FIGS. 6A and 6B, illustrate example diagrams of virtual backgrounds, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6A and FIG. 6B, as will be understood by a person of ordinary skill in the art.

For purposes of simplicity, many of the examples provided herein have been illustrated with an ideal even distribution of reflected ambient light. However, a more common scenario may be where a light source directionally impinges on the surface of the check and its associated background surface. For example, when processing check imagery, light from an adjacent window may result in an uneven distribution of pixel luminance. In these environments, the light sources may cause ambiguity around a portion of the check on a side closest to the light source. These areas of bright ambient light may include pixel luminance values similar to the check luminance values and result in a contrast ratio that is not above the previously described threshold.

FIGS. 6A and 6B are two examples of selectively replacing all or a portion of background pixels that include these high luminance light reflections (e.g., bright lights). In a first aspect, FIG. 6A illustrates an example check 106 with background 618 that may include a region of pixels 604 being illuminated by an incident light source 602. The light source will produce reflected ambient light values at the ambient light sensor 314 that may be very close in value to reflections from the check surface without a well-defined demarcation line in-between. In this case, a darker virtual background, such as FIG. 5 virtual background 3 (508), would be automatically selected and overlaid as a full or partial virtual background (608) by replacing all pixels or just pixels that were affected by the light source (e.g., area 604) with pixels of a similar luminance and color values 606 as the background not affected by the light source. The combined background 610 (e.g., real background plus partial virtual background 608) would provide a background revealing the check's perimeter based on the combined background reaching a contrast ratio threshold. Replacing all or just the affected pixels (or pixel areas) with virtual background pixels surrounding a perimeter of the check eliminates errors caused by low contrast backgrounds.

In a second aspect, FIG. 6B illustrates an example check 106 with background 620 that may include an reflective object 612 proximate to the check and on the background surface. The reflective object 612 may reflected ambient light values at the ambient light sensor 314 that may be very close in value to reflections from the check surface and potentially obfuscate a well-defined demarcation line between check and background. In this case, a darker virtual background, such as FIG. 5 virtual background 3 (508), would be automatically selected and overlaid as a full or partial virtual background 614 by replacing pixels that were affected by the object reflections. The combined background 616 (real plus virtual) would provide a background revealing the check's perimeter based on the combine background reaching a contrast ratio threshold. Replacing affected pixels (or pixel areas) with virtual background pixels surrounding a perimeter of the check eliminates errors caused by reflecting objects proximate to the check surface.

In these examples, instead of directing the user to place the check on a darker or lighter surface, the system will automatically overlay a full or partial high contrast virtual background around the check, where partial equates to one or more pixels or contiguous areas of pixels.

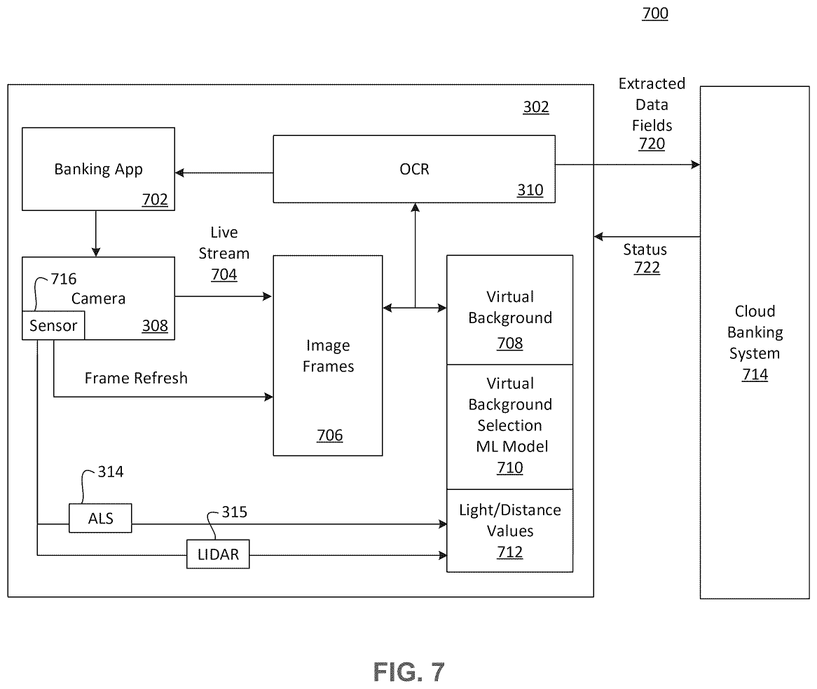

FIG. 7 illustrates an example diagram of a remote deposit system 700, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

A customer initiates a remote deposit process by opening an application (App) and then making a request to deposit a check. The process, once initiated, activates a camera 308 on the client device 302 to begin processing imagery from a raw video stream. The live video stream 704 may be detected by an active-pixel sensor 716 (such as a complementary metal-oxide-semiconductor (CMOS) image sensor or a charge-coupled device (CCD). In CCDs, there is a photoactive region (an epitaxial layer of silicon), and a transmission region made out of a shift register. An image is first projected through a lens onto the photoactive region of the CCD, causing each capacitor of a capacitor array to accumulate an electric charge proportional to the light intensity at that location. A one-dimensional array, used in line-scan cameras, processes a single slice of the image, whereas a two-dimensional array, used in video and still cameras, processes a two-dimensional picture corresponding to the scene projected onto the focal plane of the sensor. Once the array has been exposed to the image, a control circuit causes each capacitor to transfer its contents to its neighbor (operating as a shift register). The last capacitor in the array dumps its charge into a charge amplifier, which converts the charge into a voltage. By repeating this process, the controlling circuit converts the entire contents of the array in the semiconductor to a sequence of voltages. These voltages are then sampled, digitized, and may be stored as image frames 706 in computer memory within client device 302, such as image memory 312.

In some embodiments disclosed herein, the client device 302 may include various sensors to assist with a remote deposit processing of check 106. For example, as previously disclosed, ambient light sensor (ALS) 314 and LIDAR sensor 315 may provide ambient light and distance values 712, respectively, to a virtual background selection ML model 710 to select a virtual background 708 that satisfies a selectable contrast ratio threshold.

In one aspect, an ambient light sensor 314 resident on a client device manages image object processing sequences. For example, ambient light sensor 314 may determine that a check and its background do not have a contrast ratio above a threshold (e.g., to determine check perimeter). In cases where the contrast ratio is not above a preset threshold, a virtual background 708 will be selected by a machine learning (ML) algorithm (e.g., by a virtual background selection ML model 710). The model may select a virtual background 708 from a set of backgrounds to maximize the contrast ratio. The selected virtual background 708 is overlaid as a new background surrounding a perimeter of the check for image frames 706, thus eliminating errors caused by low contrast backgrounds. These processes may be directed by a mobile banking app or other image processing app and the video processed by an OCR system 310 process in real-time or near real-time.

In one aspect, a LIDAR based sensor resident on client device 302 manages image object processing sequences. For example, LIDAR sensor 315, resident on the client device 302, is configured to determine a distance or range of distances of the check from the client device. For example, by targeting the check, the surface the check is positioned on, or a combination of both, a laser generates light pulses that are reflected from these objects and a time for the reflected light to return to the receiver is measured as a distance. LIDAR may operate in a fixed direction (e.g., vertical) or it may scan multiple directions, in which case it is known as LIDAR scanning or 3D laser scanning, a combination of 3-D scanning and laser scanning. In the various embodiments and aspects disclosed herein, the LIDAR functionality is built-in to the client device 302. In some aspects, gyroscope data (e.g., gyroscope 118 (See FIG. 1) may assist LIDAR functionality by providing angular measurements other than distance. In this aspect, distance is combined with angular position of the client device 302 to provide a clearer understanding of a relationship of the client device 302 to the check 108 and/or the surface that it rests on. Angular measurements may also assist in determining a shape of the check and/or virtual background 708. These processes may be directed by a mobile banking app or other image processing app and imagery processed in real-time or near real-time.

In one aspect, OCR system 310 extracts data fields from the formed byte array objects located within the virtual background area. For example, OCR system 310 extracts or identifies a check date, check number, payor, payee, amount, payee information, and bank information, to name a few. In one embodiment, forming of image objects (e.g., image frames 706) from live video stream 704 may be paused during a flip detection sequence and then resumed when the flip has been completed. While extracting identifiable data from surfaces of the check is a primary output of the OCR, additional post-processing may be needed to further confirm or verify the data.

Cloud Banking System 714 (consistent with cloud banking system 316) receives the extracted data fields 720 of the check from the client device 302. In one non-limiting example, single identifiable data fields, such as the check field 206, date field 208, payee field 210, amount field 212, etc., are sequentially extracted and communicated by the OCR system 310 in real-time as they are detected and OCR processed. For example the MICR line 220 that includes a string of characters including the bank routing number and the payor's account number, may be processed before other data fields to immediately initiate a verification of the payor, while the OCR system 310 processes the remaining fields on one or more additional images, or partial images. Alternatively, or in addition to, the OCR system 310 may have a time ordered sequence of fields to be processed. Alternatively, or in addition to, all identifiable check fields are processed simultaneously in parallel by the OCR system 310 across multiple confidence scored images, or partial images.

Cloud banking system 714 communicates a remote deposit status 722 to banking app 702 on the client device 302. For example, the acceptance of the OCR processed data is communicated. Alternatively, a request to continue pointing the camera at one or more sides of the check is communicated to and rendered as on-screen instructions on the client device 302, within one or more user interfaces (UIs) of the customer device's mobile banking app 304. The rendering may include imagery, text, or a link to additional content. The UI may instantiate the remote deposit status as images, graphics, audio, etc. In another technical improvement over existing systems, the remote deposit status is provided mid-video stream, prior to completion of the deposit. In this approach, the customer may terminate the process prior to completion if they are dissatisfied with the remote deposit status or if they identify that an error has occurred.

Alternatively, or in addition to, one or more components of the remote deposit flow may be implemented within the customer device, third party platforms, distributed across multiple computer-based systems, or combinations thereof.

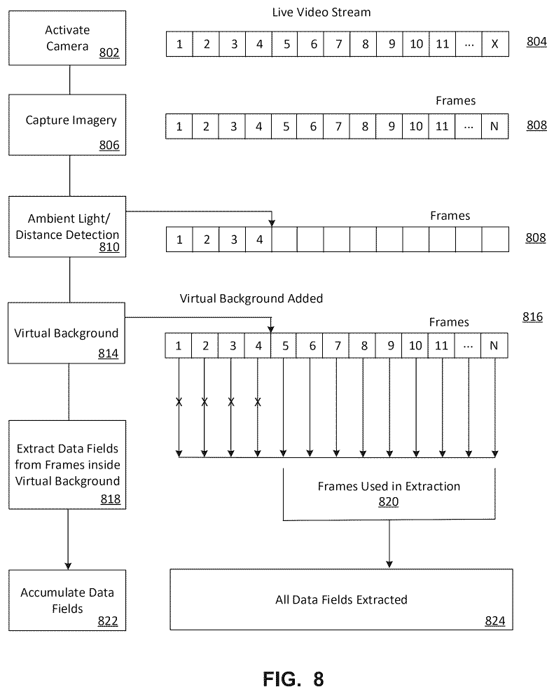

FIG. 8 is a flow chart 800 depicting an OCR process for a remote check deposit that can be carried out in line with the discussion above. One or more of the operations in the method depicted by FIG. 8 may be carried out by one or more entities, including, without limitation, client device 302, cloud banking system 316, cloud banking system 714, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some aspects, the systems described generate and instantiate an active OCR process for a ranked sequence of confidence scored images in a remote deposit environment.

In 802, a mobile banking app 304 initiates a remote deposit by activating a camera 308 of client device 302. For example, a customer using a mobile computing device 102, operating a mobile banking app 304, initiates a remote deposit by selecting this option on a UI of the banking mobile app on their mobile computing device. This selection provides instructions to the camera 104 to communicate image data from the field of view 108 of the camera as a raw live video stream 804 of image data 1, 2, 3 . . . . X, where X is a number of pixels of image data.

In 806, the raw live image video stream 804, for example, pixels 1, 2, 3 . . . . X, is converted to byte array objects 808 (1-N), such as image frames or partial frames, consistent with previously described byte array objects. In one aspect, the raw live video stream 804 of image data may be continuously formed into byte array objects until an OCR process has extracted selected data fields from a first side of the check. Alternatively, the raw live video stream 804 of image data may be continuously formed into byte array objects until an OCR process has extracted all data fields from the imagery of both sides of the check.

In 810, an ambient light/distance detection action is implemented for one or more financial instruments (e.g., checks). In some embodiments, if the contrast ratio between the light luminance value pixels and the dark luminance value pixels does not exceed a predetermined threshold, the forming of byte array objects (e.g., image frames) is paused. For example, the forming of image objects is paused until a virtual background is selected in step 814 that meets the predetermined threshold. Alternatively, or in addition to, the image objects are continuously formed (e.g., without a pause), but the image objects captured before a virtual background has been selected and overlaid onto the check perimeter pixels are not processed (e.g., discarded or ignored) by the OCR system 310 process. In some aspects, the virtual background may be predicted by a trained ML model trained on previous deposit imagery. In some aspects, the virtual background may be a partial virtual background and replace pixels affected by anomalies, such as a light source or reflective surface or object proximate to a check.

In 814, with the virtual background selection and overlay action completed, the forming of byte array objects is restarted from subsequent frames 820 (shown as frames 5-N) and the OCR of subsequent image frames is performed. The OCR process may determine a number of byte array objects needed to meet a selected success rate. For example, the camera would remain active until targeted extractions are available.

In 818, in some aspects, the OCR system 310 processes only pixels found within an inner perimeter of the virtual background of frames 820, to include one or both of the first and second side of the check. In each OCR process, a maximum number of data fields are extracted from each of the byte array objects until the target set of data fields has been extracted. In addition, the byte array objects may include a full frame of data or be any portion of an image formed from the raw live image video stream 804. For example, as an upper corner of an image is being formed into a byte array and the OCR system 310, in real-time, extracts any data fields located in this portion of the image. In a non-limiting example, as the customer moves their client device 302 around (e.g., standing over the check with at least a portion of the check in the field of view), a live image video stream 804 is being generated that can be formed into byte array objects and active OCR processed.

In 822, extracted data fields are accumulated until all target data fields have been extracted 824. These extracted data fields are communicated sequentially or all at once to the cloud banking system.

This approach provides a technical solution to effectively extract data fields from check imagery where the check is positioned on a surface with a similar luminosity as the check or a proximate reflective surface with a similar luminosity. For example, a user may move the client device around freely as the camera generates a live video stream of potentially good (in-focus, good lighting, low shading, etc.) and bad quality imagery (e.g., shadows, glare, shiny objects, or off-center) without requiring the user to retake a picture or communicate poor quality pictures to a remote OCR system, thus allowing for real-time extraction of the check data fields. In addition, an additional technical advantage is achieved by pausing forming byte arrays or active OCR of imagery that is generated during the flip action (e.g., by detecting a shape change of a virtual background). This pause reduces errors occurring during the flip, as well as efficiently allocating limited client device resources.

During OCR processing, the images may be first rectified to correct for distortions based on an angle of incidence, or may be rotated to align the images, or may be resized to allow same size image overlay configurations. In one aspect, these corrections may be based on recognition of corners or a perimeter of the check.

While described throughout for client-side OCR processing, in some aspects, the OCR process may be any process that can extract data fields from the formed byte array objects, including remote systems and processes.

FIG. 9 illustrates a block diagram of a ML system 900, according to some embodiments and aspects. A virtual background selection implementation may include one or more system servers processing various banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 9, as will be understood by a person of ordinary skill in the art.

In some aspects, a virtual background selection model 908 (e.g., virtual background selection model 710) may be processed locally on the client device 302 to improve check data field extraction performance, such as accuracy, quality and speed, to name a few. In various aspects, virtual background selection model 908 may be a standalone model or be integrated within mobile banking app 304 (as shown), or within OCR system 310. ML models (1-N) 918 may singularly, or collectively, implement any of, but are not limited to, a ML predictive model for virtual background selection, a ML model for image quality scoring, a ML model for selecting an optimum number of quality scored byte array objects, a ML model for communicating the selected byte array objects to an OCR process, and a ML model for determining when a target set of desired check data fields have been extracted.

In some aspects, ambient light luminance values 902 and LIDAR/gyroscope 904 measurement data may be used by the ML platform 329 as contrast and/or distance values 910 to determine a virtual background that meets or exceeds a contrast ratio threshold or to provide updated training values.

Training of any of the described ML models may occur remotely from the client device 302 (e.g., in ML platform 329) and be communicated to the client device 302 as one or more ML model(s) 918 are trained and updated. Training may include exposing the ML models to the data of hundreds, thousands, or more of historical image data 912, where specific imagery with labeled contrast ratios or distances from a camera and subsequent success of data field extractions, may be included in a supervised model build. Image contrast ratio thresholds may be selectable and varied during the training process to generate an optimized threshold based on a historical correlation with successful OCR extracted data fields. Trained ML models 920 may each have varied metadata weightings, performance weightings, or quality weightings, but are not limited to these parameter weightings. One skilled in ML would appreciate that any of the parameters used in the virtual background process, such as, but not limited to, performance targets may have weighting varied without departing from the scope of the technology disclosed herein.

Machine learning may involve computers learning from data provided so that they carry out certain tasks. For more advanced tasks, it can be challenging for a human to manually create the needed algorithms. This may be especially true of teaching approaches to correctly identify patterns. The discipline of machine learning therefore employs various approaches to teach computers to accomplish tasks where no fully satisfactory algorithm is available. In cases where vast numbers of potential answers exist, one approach, supervised learning, is to label some of the correct answers as valid or successful. For example, a high quality image may be correlated with a confidence score based on previously assigned quality ratings of a number of images. This may then be used as training data for the computer to improve the algorithm(s) it uses to determine future successful outcomes.

As shown, a series of desired models 918, 1-N, may be fed into the ML Engine 916 as predictor models to select a virtual background from a set of virtual backgrounds 914. The ML model(s) 918 may be trained and continuously improved by analyzing relative success over a large data set, where success is measured by quality of OCR data field extractions. ML models 918 may be focused to generate queries for a specific performance level, for example selecting a virtual background in a minimum time (e.g., less than some number of microseconds).

Imagery 906 received from the client device, including the byte object arrays used in the OCR process, may be stored in the User Account DB 922. User Account DB 922 may also store user profile information that may be used with a remote deposit platform to provide account and profile information based on associated identifiers (IDs). Additionally, as specific funds availability schedules are presented to the user, for example, as rendered on their user device 302 through mobile banking app 304, the historical information may be added to the user's profile, and further be stored in the User Account DB 922.

Alternatively, or in addition to, one or more components of the ML platform 329 may be implemented within the user's mobile device, third party platforms, and a cloud-based system, or distributed across multiple computer-based systems.

The various aspects solve at least the technical problems associated with performing OCR operations pre-deposit, without requiring communication of an image capture to a remote OCR system. The various embodiments and aspects described by the technology disclosed herein are able to provide active OCR operations and remote deposit status mid-experience, before the customer completes the deposit and without requiring the customer to provide additional new image captures post image quality or OCR failures.

This solution improves the quality of the check processing process, accelerates the remote check deposit process, and allows mid-video stream alterations or improvements, for example, real-time image quality guidance or customer inputs (e.g., mid-video stream cancelation), as well as the other technical advantages described throughout this disclosure.

### Example Computer System

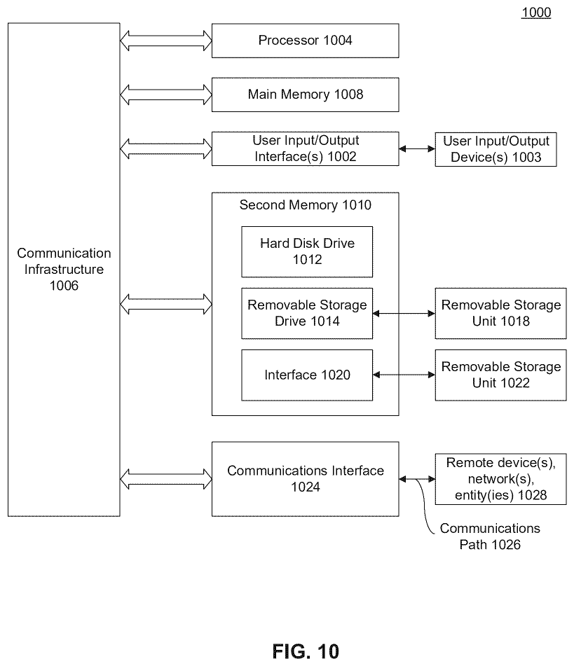

FIG. 10 depicts an example computer system useful for implementing various embodiments.

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof. For example, the example computer system may be implemented as part of mobile computing device 102, client device 302, cloud banking system 316, ML Platform 329, etc. Cloud implementations may include one or more of the example computer systems operating locally or distributed across one or more server sites.

Computer system 1000 may include one or more processors (also called central processing units, or CPUs), such as a processor 1004. Processor 1004 may be connected to a communication infrastructure or bus 1006.

Computer system 1000 may also include user input/output device(s) 1002, such as monitors, keyboards, pointing devices, etc., which may communicate with communication infrastructure 1006 through user input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1018 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1016 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A computer-implemented method for a client device, comprising:
detecting, by a camera on the client device, a field of view of the camera;
measuring, based on the field of view of the camera, first ambient light luminance values of a first contiguous surface area and second ambient light luminance values of a second contiguous area at least partially surrounding the first contiguous surface area, wherein the first contiguous surface area includes image pixels of a document and the second contiguous surface area includes image pixels of a background of the document;
determining a contrast ratio of the first ambient light luminance values and the second ambient light luminance values;
selecting, based on the contrast ratio not exceeding a preselected threshold value, a virtual background, wherein the virtual background meets or exceeds the preselected threshold value; and
replacing at least a portion of the image pixels of the background of the document with the virtual background; and
recognizing at least a partial perimeter of the document based on the virtual background.

2. The computer-implemented method of claim 1, further comprising:
performing an optical character recognition (OCR) process on imagery located within the at least partial perimeter of the document to extract data fields; and
communicating the extracted data fields to a remote server.

3. The computer-implemented method of claim 2, wherein the document is a financial instrument, and the method further comprises the OCR process extracting the data fields from the financial instrument for a remote deposit of the financial instrument.

4. The computer-implemented method of claim 3, wherein the imagery comprises a partial frame or an entire frame of the financial instrument.

5. The computer-implemented method of claim 3, further comprising: detecting, based on a Light Detection and Ranging (LIDAR) sensor, a measurement of distances from the camera on the client device to the financial instrument.

6. The computer-implemented method of claim 5, wherein the distances from the camera to the financial instrument are categorized within one or more ranges of distances.

7. The computer-implemented method of claim 3, further comprising selecting the virtual background based on a trained machine learning model.

8. The computer-implemented method of claim 3, further comprising categorizing imagery for training the trained machine learning model based on the distances from the camera to the financial instrument, as labeled in historical document imagery.

9. The computer-implemented method of claim 1, further comprising, detecting, based on a change in shape of the virtual background, a flip action of the financial instrument.

10. A system, comprising:
a memory; and
at least one processor coupled to the memory and configured to:
detect, by a camera on a client device, a field of view of the camera;
measure, based on the field of view of the camera, first ambient light luminance values of a first contiguous surface area and second ambient light luminance values of a second contiguous area at least partially surrounding the first contiguous surface area, wherein the first contiguous surface area includes image pixels of a document and the second contiguous surface area includes image pixels of a background of the document;
determine a contrast ratio of the first ambient light luminance values and the second ambient light luminance values;
select, based on the contrast ratio not exceeding a preselected threshold value, a virtual background, wherein the virtual background meets or exceeds the preselected threshold value; and
replace at least a portion of the image pixels of the background of the document with the virtual background; and
recognize at least a partial perimeter of the document based on the virtual background.

11. The system of claim 10, comprising an ambient light sensor to measure the first ambient light luminance values of a first contiguous surface area and the second ambient light luminance values of a second contiguous area.

12. The system of claim 10, wherein the document is a financial instrument, and the at least one processor is further configured to extract data fields from the financial instrument for a remote deposit of the financial instrument.

13. The system of claim 12, comprising a Light Detection and Ranging (LIDAR) sensor for measuring a distance from the camera on the client device to the financial instrument.

14. The system of claim 10, wherein the at least one processor is further configured to categorize imagery for training a machine learning model based on the distance from the camera to the financial instrument, as labeled in historical document imagery.

15. The system of claim 10, wherein the at least one processor is further configured to select the virtual background based on a trained machine learning model.

16. The system of claim 10, wherein the at least one processor is further configured to detect, based on a change in shape of the virtual background, a flip action of the document.

17. A non-transitory computer-readable device having instructions stored thereon that, when executed by at least one computing device, causes the at least one computing device to perform operations comprising:
activating, on the client device, a remote deposit application;
activating, based on receiving a user request to initiate a remote deposit, a camera on the client device, wherein the camera provides access to a field of view of the camera;
detecting, within the field of view of the camera, first ambient light luminance values of a document and second ambient light luminance values of a background area;
determining of a contrast ratio of the first ambient light luminance values and the second ambient light luminance values;
overlaying, based on the contrast ratio not exceeding a preselected threshold, a virtual background over at least a portion of the background area; and
processing imagery of the document.

18. The non-transitory computer-readable device of claim 17, wherein the operations further comprise extracting data fields from the financial instrument for the remote deposit of the financial instrument.

19. The non-transitory computer-readable device of claim 17, wherein the operations further comprise selecting the virtual background based on a trained machine learning model.

20. The non-transitory computer-readable device of claim 19, wherein the operations further comprise measuring a distance from the camera to the financial instrument and inputting the distance to the trained machine learning model to assist in the selecting the virtual background.
